(19) United States
(12) Patent Application Publication
(10) Pub. No.: US 2011/0063167 A1
(43) Pub. Date: Mar. 17, 2011

(54) USING MAGNETOMETER WITH A POSITIONING SYSTEM

(75) Inventors: Arnold J. Gum, San Diego, CA (US); Lionel J. Garin, Palo Alto, CA (US)

(73) Assignee: QUALCOMM Incorporated, San Diego, CA (US)

(21) Appl. No.: 12/560,207

(22) Filed: Sep. 15, 2009

(51) Int. Cl. G01S 19/26; G01C 17/00

(52) U.S. Cl. 342/357.65; 33/355 R

(57) ABSTRACT

A mobile station determines an approximate latitude using a measured feature of the Earth's magnetic field. An approximate longitude may also be determined. The mobile station uses the approximate latitude and longitude, if determined, to assist in determining a position fix for the mobile station, e.g., by determining a list of visible satellites in a satellite positioning system (SPS) during search and acquisition of satellite signals and/or using the approximate position as a seed position in the position computation. The feature of the Earth's magnetic field may be, e.g., inclination or vertical intensity, and may be determined using data from a three-dimensional magnetometer and a three-dimensional accelerometer. An instantaneous value of the magnetic field feature may be averaged to reduce the affects of motion and the presences of large metallic masses.

### CROSS-REFERENCE TO RELATED APPLICATION(S)

This application claims the benefit of U.S. Provisional Application No. 60/110,078, filed Oct. 31, 2008, which is incorporated herein by reference.

### BACKGROUND

A common means to determine the location of a device is to use a satellite position system (SPS), such as the well-known Global Positioning Satellite (GPS) system or Global Navigation Satellite System (GNSS), which employ a number of satellites that are in orbit around the Earth. Position measurements using SPS are based on measurements of propagation delay times of SPS signals broadcast from a number of orbiting satellites to an SPS receiver. Once the SPS receiver has measured the signal propagation delays for each satellite, the range to each satellite can be determined and precise navigation information including 3-dimensional position, velocity and time of day of the SPS receiver can then be determined using the measured ranges and the known locations of the satellites.

Before the SPS receiver can receive an SPS signal, however, the SPS receiver must locate the satellite relative to the receiver. Typically, the SPS receiver must locate at least four orbiting satellites before a position fix may be performed. The location of the satellites within the SPS system can be identified by a number of different pieces of information. For example, the almanac and ephemeris provide information regarding the location of all of the satellites in the “constellation”, where the ephemeris information is more accurate than the almanac information. The almanac and the ephemeris information, however, is valid for only a limited amount of time, the ephemeris information being valid for a much shorter time than the almanac information.

When a SPS receiver has already acquired the satellite signals and has determined a fix of the position of the SPS receiver, the subsequent determination of position is fast. However, when the SPS receiver is powered on, or brought out of a sleep mode, a first position fix must be performed, which includes locating the satellites. The Time to First Fix (TTFF) is the time it takes to perform this first position fix. Several factors affect how long it will take to locate the satellites, and thus, the TTFF. Factors include the length of time from the last position fix and, thus, whether the SPS receiver has valid almanac and ephemeris data and whether there is a significant change in the location of the SPS receiver since the last position fix. An SPS receiver will typically have almanac information; however, the ephemeris may be expired upon start up. Thus, satellites will need to be detected and their signals demodulated to get new ephemeris so that a position fix may be performed. Typically, an SPS receiver will use the last prior fix as a seed position for searching for visible satellites. Where there is little change in location, using the last position fix as a seed position provides a fast TTFF. If, however, there has been a large change in position, e.g., after an intercontinental flight, relying on the last position fix will result in a failed satellite search. As a result, the SPS receiver may go into a recovery mode before it can lock onto the first satellite at the expense of significantly increased TTFF.

### SUMMARY

A mobile station determines an approximate latitude using a feature of the Earth's magnetic field as measured by the mobile station. The feature of the Earth's magnetic field may be, e.g., inclination or vertical intensity, and may be determined using data from a three-dimensional magnetometer and a local vertical sensor, such as a three-dimensional accelerometer. An instantaneous value of the magnetic field feature determined using a magnetometer and accelerometer may be filtered over time to reduce the affects of user motion and the presences of large metallic masses. An approximate longitude may also be determined, e.g., based on the time difference between a local time zone and a reference time zone with a known longitude, or using an external signal such as the local country code. The mobile station uses the approximate latitude and approximate longitude, if determined, to assist in determining a position fix for the mobile station. For example, the mobile station may use the approximate latitude and approximate longitude to determine a list of visible satellites in a satellite positioning system (SPS) during a search and acquisition of satellite signals for a position fix. The mobile station may also use the approximate latitude and approximate longitude as a seed position in the position computation.

### BRIEF DESCRIPTION OF THE DRAWING

FIG. 1 illustrates a mobile station that receives signals from SPS satellites and is capable of determining a coarse position fix using the Earth's magnetic field.

FIG. 2 illustrates features of the Earth's magnetic field with respect to Earth's coordinate system.

FIG. 3 illustrates the inclination angle of Earth's magnetic field.

FIG. 4 illustrates the vertical component of Earth's magnetic field.

FIG. 5 illustrates the declination angle of Earth's magnetic field.

FIG. 6 illustrates the horizontal component of Earth's magnetic field.

FIG. 7 illustrates the total intensity component of Earth's magnetic field.

FIG. 8 illustrates a block diagram of a mobile station capable of determining a coarse position using the Earth's magnetic field.

FIG. 9 illustrates a flow chart showing a method of determining a coarse position fix using the Earth's magnetic field.

FIG. 10 illustrates the three-dimensional coordinate system of a magnetometer with respect to the three-dimensional coordinate system of an accelerometer.

FIG. 11 shows a block diagram illustrating the determination of a value of a feature of the Earth's magnetic field using a magnetometer and accelerometer and using that value to determine an approximate latitude of the mobile station.

FIG. 12 shows a block diagram illustrating the determination of longitude using the local time and the time at a location with a known position.

### DETAILED DESCRIPTION

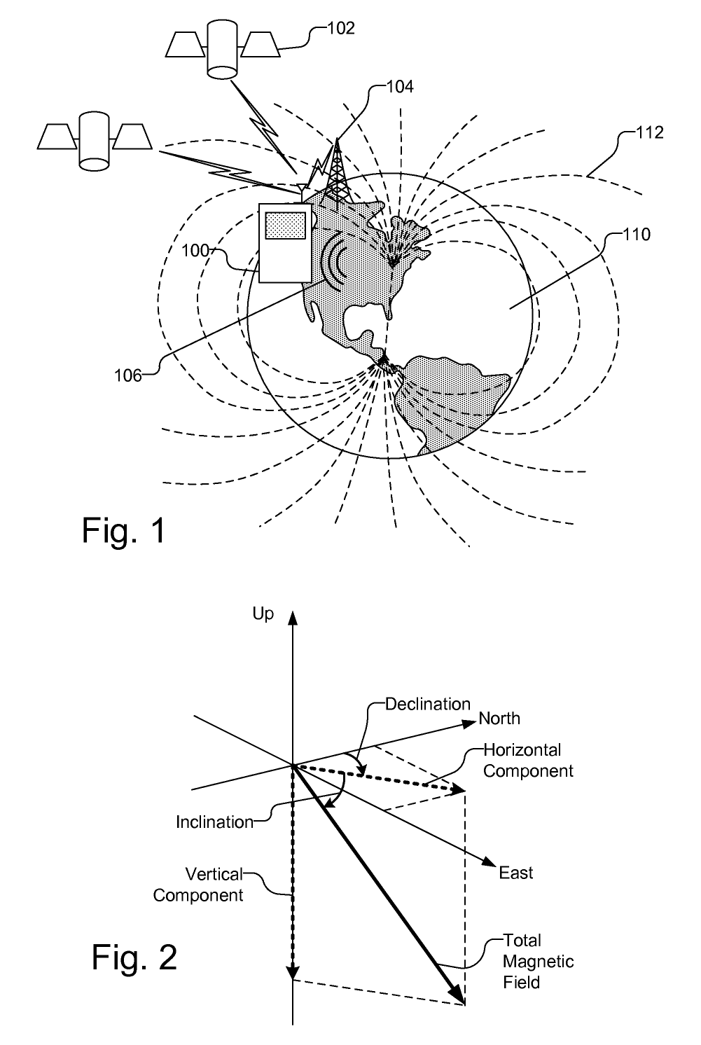

FIG. 1 illustrates a mobile station 100 that is capable of performing a coarse position fix using the magnetic field 112 of the Earth 110. The mobile station 100 may also use the local time, e.g., as received from a cellular towers 104 or wireless communication access points 106, or the like, to assist in performing the coarse position fix. A course position fix may be used to assist in the search for satellites 102 in a satellite positioning system that are visible to the mobile station during search and acquisition of satellite signals for a position fix. For example, the coarse position may be used to determine if the last position fix may be used as the seed position for the search for satellites and, if not, the coarse position may be used as the seed position. Using a coarse position determined using the Earth's magnetic field 112 along with the Almanac information permits the mobile station to detect satellites in significantly less time than if a worldwide search is performed.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass).

In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile station 100, however, is not limited to use with an SPS, but position determination techniques described herein may be implemented in conjunction with various wireless communication networks, including cellular towers 104 and from wireless communication access points 106, such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

As used herein, a mobile station refers to a device that is capable of determining position location and may be, e.g., a dedicated SPS receiver, including a handheld or vehicular mounted system, or cellular or other wireless communication device, personal communication system (PCS) device, personal navigation device, Personal Information Manager (PIM), Personal Digital Assistant (PDA), laptop or other suitable mobile device which is capable of receiving wireless navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

The mobile station 100 includes a magnetic field sensor, such a three-dimensional magnetometer, to detect one or more features of the Earth's magnetic field 112. The values of the magnetic field feature with respect to location on the Earth are known and may be included in a table stored in the mobile station 100. The value of the magnetic field feature as measured by the mobile station 100 can be compared to the table to determine a coarse position for the mobile station 100. For example, the inclination angle and/or vertical component of the magnetic field may be used to provide a rough latitude position of the mobile station 100. Moreover, the local time may be used to determine a coarse longitude position, thereby creating the boundaries for a search window or a seed position for the position calculation.

FIG. 2 illustrates various features of the Earth's magnetic field with respect to Earth's coordinate system, e.g., North/South; East/West; and Up/Down. As can be seen, the total magnetic field is a vector that is in the North/South; East/West; and Up/Down space. The horizontal component is the value of the total magnetic field projected on the horizontal plane defined by the North/South and East/West coordinates and declination is the angle that the horizontal component varies from true North. The inclination is the angle that the total magnetic field varies from the horizontal plane and the vertical component is value of the total magnetic field projected on the vertical (Up/Down) axis.

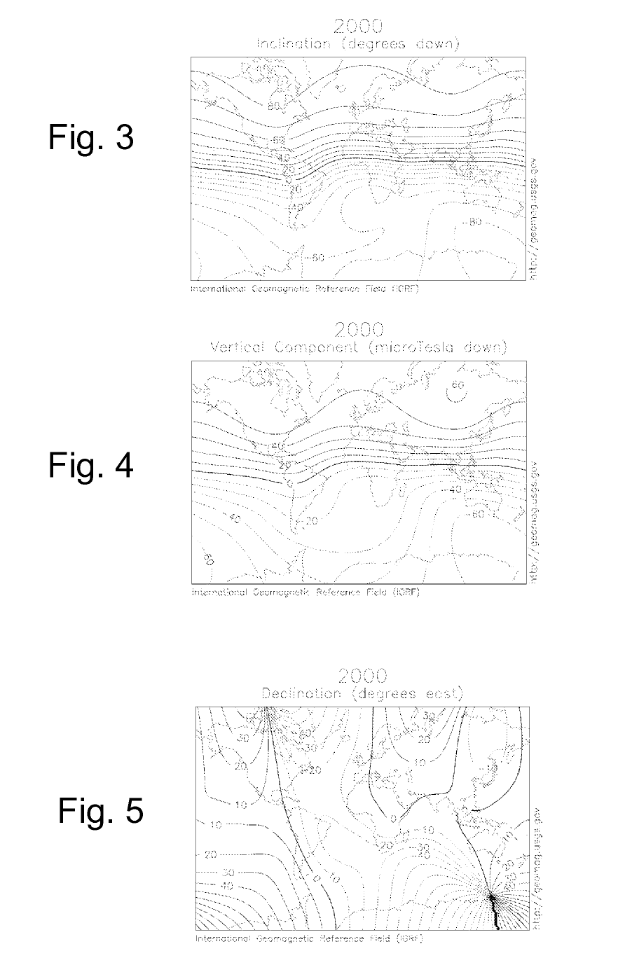

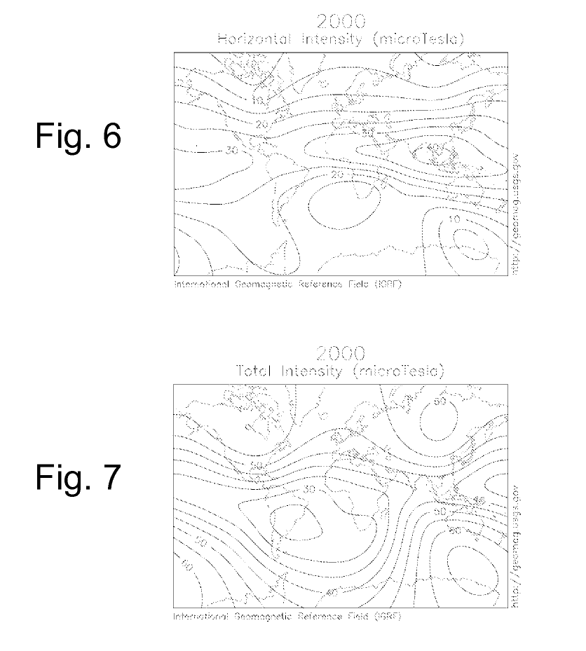

FIGS. 3, 4, 5, 6, and 7 illustrate International Geomagnetic Reference Field maps of the inclination, vertical intensity, declination, horizontal intensity and total intensity, respectively, of the Earth's magnetic field for the year 2000. As can be seen in FIG. 3, the iso-inclination lines run approximately parallel to latitude and thus, an approximate latitude can be obtained from the inclination information (i.e. magnetic field orientation angle vs. local horizon). FIG. 4 shows the iso-vertical intensity lines also run approximately parallel to latitude, and thus, may be used to provide an approximate latitude. By way of example of the achievable accuracy, looking at the inclination map in FIG. 3, on the 128 W meridian (roughly Los Angeles longitude), the inclination goes from 55° down at 30° latitude to 72° down at 50° latitude, which is approximately a 1° of latitude increase per degree of inclination decrease. Thus, if the determination of the inclination vs. vertical has an uncertainty of about +/−5°, the uncertainty in the latitude is approximately ±550 km (≈±5(°)*60(′/°)*(1852(m/′). The accuracy of the determination of the latitude determined by the Earth's magnetic field is adequate to provide an approximate latitude for satellite visibility or seeding the GPS position computation.

As can be seen in FIGS. 3, 4, 5, 6 and 7, only the vertical intensity shown in FIG. 4 is truly monotonic in longitude, i.e., there is only one latitude associated with a given vertical intensity value along any meridian. As can be seen in FIG. 3, inclination is mostly monotonic and is monotonic in inhabited regions. The only non-monotonic location in the inclination shown in FIG. 3 is South of Africa, where the −60 microtesla line reverses back onto the same meridian. This area, however, is a non-inhabited area and is likely not to be a problem.

Moreover, over time, e.g., from about 1850 to 1990, both the inclination and the vertical intensity have been stable, with the vertical intensity most stable. Thus, both inclination angle and vertical intensity are suitable for deriving an approximate position. If desired, however, other features of the magnetic field, e.g., total intensity shown in FIG. 7, or combinations of the features may be used to derive an approximate position of the mobile station 100.

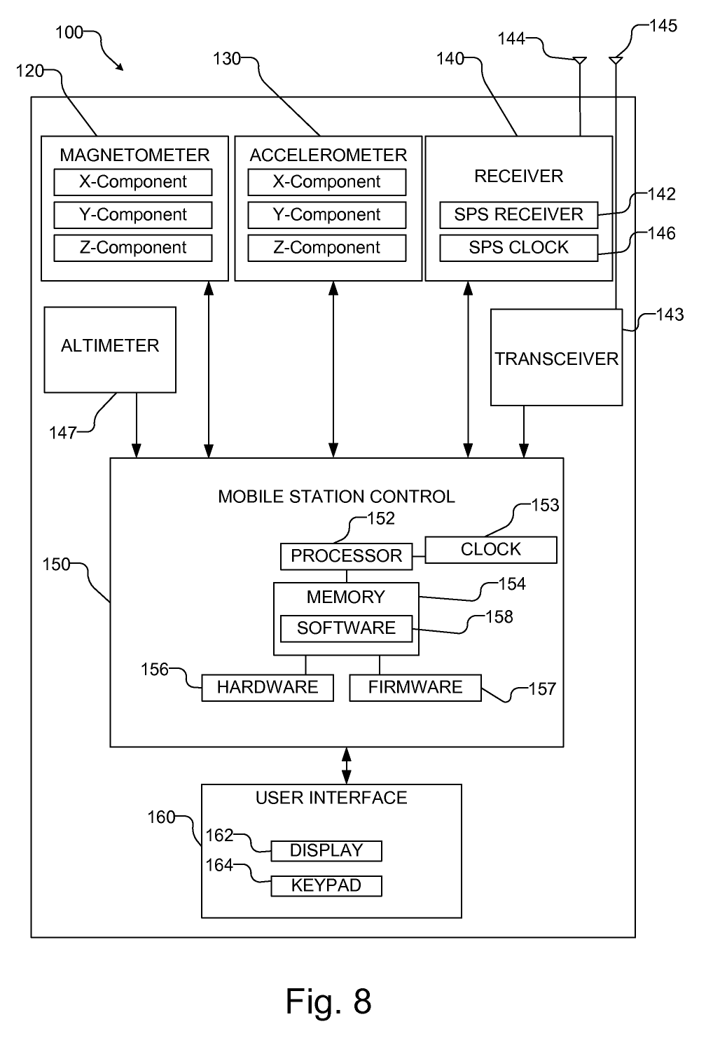

FIG. 8 is a block diagram of the mobile station 100 capable of determining a coarse position fix using the Earth's magnetic field. In order to measure a feature of the Earth's magnetic field, the mobile station 100 includes a three-dimensional magnetometer 120. Additionally, to determine the inclination of the magnetic field or the intensity of the vertical component, the mobile station 100 includes a vertical sensor, i.e., a sensor that can determine the local vertical. In one embodiment, the vertical sensor is a three-dimensional accelerometer 130, which may be used as a tiltometer for the determination of the local vertical. The three axes of sensitivity of both the magnetometer 120 and the accelerometer 130 (labeled as X-Component, Y-Component, and Z-Component) are mutually aligned, or at least have a known orientation with respect to each other, e.g., the orientation may be known at a sub-degree accuracy level.

Mobile station 100 includes a receiver 140, such includes a satellite positioning system (SPS) having a SPS receiver 142 that receives signals from a SPS satellites 102 (FIG. 1) via an antenna 144 and a SPS clock 146. As discussed in reference to FIG. 1, the receiver 140 need not be limited to SPS, but may also receive signals from terrestrial sources, such as cellular towers 104 or from wireless communication access points 106. The mobile station 100 may also include a transceiver 143 that sends and receives signals via antenna 145, which may serve as, e.g., a cellular modem or a wireless network radio receiver/transmitter that is capable of transmitting and receiving communications from a cellular tower or from a wireless access point, respectively. If desired, receiver 140 and transceiver 143 may be combined. The mobile station 100 may include additional devices as well, such as an altimeter 147.

The magnetometer 120, accelerometer 130, receiver 140, transceiver 143 and altimeter 147 are connected to and communicate with a mobile station control 150. The mobile station control 150 accepts and processes data from the various devices in the mobile station, such as the magnetometer 120, the accelerometer 130 and the receiver 140 and controls the operation of the device. The mobile station control 150 may be provided by a processor 152 and associated memory 154, a clock 153, hardware 156, software 158, and firmware 157. It will be understood as used herein that the processor 152 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile station, and is not to be limited to any particular type of memory or number of memories, or type of media upon which memory is stored.

The mobile station 100 also includes a user interface 160 that is in communication with the mobile station control 150, e.g., the mobile station control 150 accepts data and controls the user interface 160. The user interface 160 includes a display 162 that displays position information as well as control menus and a keypad 164 or other input device through which the user can input information into the mobile station 100. In one embodiment, the keypad 164 may be integrated into the display 162, such as a touch screen display. The user interface 160 may also include, e.g., a microphone and speaker, e.g., when the mobile station 100 is a cellular telephone.

The methodologies described herein may be implemented by various means depending upon the application. For example, these methodologies may be implemented in hardware 156, firmware 157, software 158, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 154 and executed by the processor 152. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

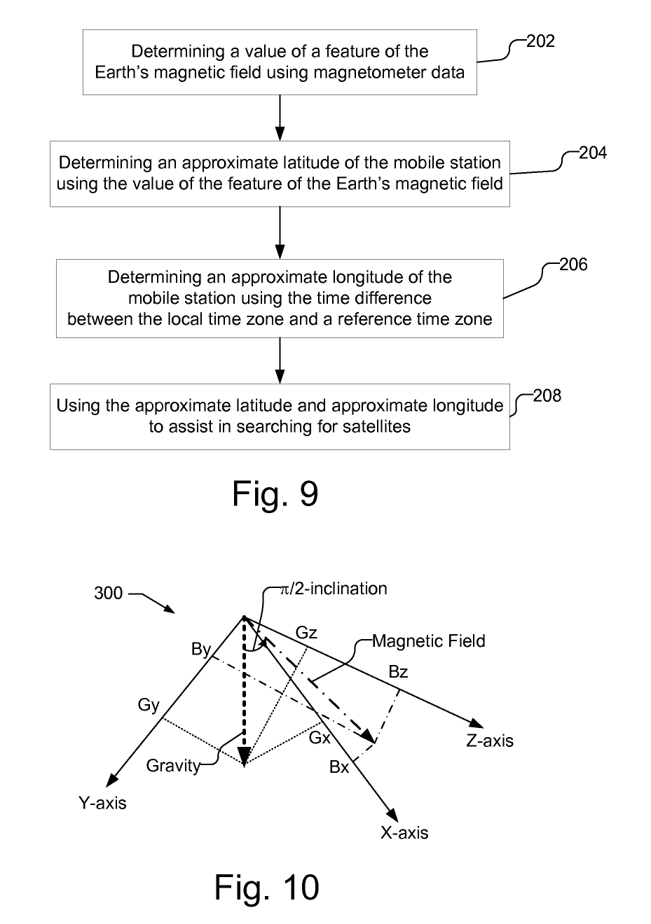

FIG. 9 is a flow chart showing a method of determining a coarse position fix using the Earth's magnetic field and using the coarse position fix to assist in searching for satellites, e.g., by determining if the current seed position is still useful/consistent and, if not, using coarse position as the seed position and to expand the search window size based on the uncertainty of the coarse position. As illustrated in FIG. 9, the mobile station 100 determines a value of at least one feature of the Earth's magnetic field using magnetometer data (202) and uses the value of the component to determine an approximate latitude of the mobile station (204). By way of example, the inclination angle or vertical intensity of the magnetic field may be used.

The inclination angle or vertical intensity of the Earth's magnetic field may be determined using the magnetometer 120 of the mobile station 100 with reference to the local vertical direction. The local vertical direction may be determined using a vertical sensor, such as the accelerometer 130, illustrated in FIG. 8, operating as a tiltometer. FIG. 10 illustrates a common reference system 300 for the magnetometer 120 and the accelerometer 130 oriented in an arbitrary down position with respect to the local vertical, which is labeled “Gravity”. As illustrated in FIG. 10, the three sensitive axes of the magnetometer 120 and accelerometer 130 are aligned with each other. It should be understood, however, that the axes of the magnetometer 120 and accelerometer need not be aligned, but the orientation of the axes with respect to each other should be known with sub-degree accuracy.

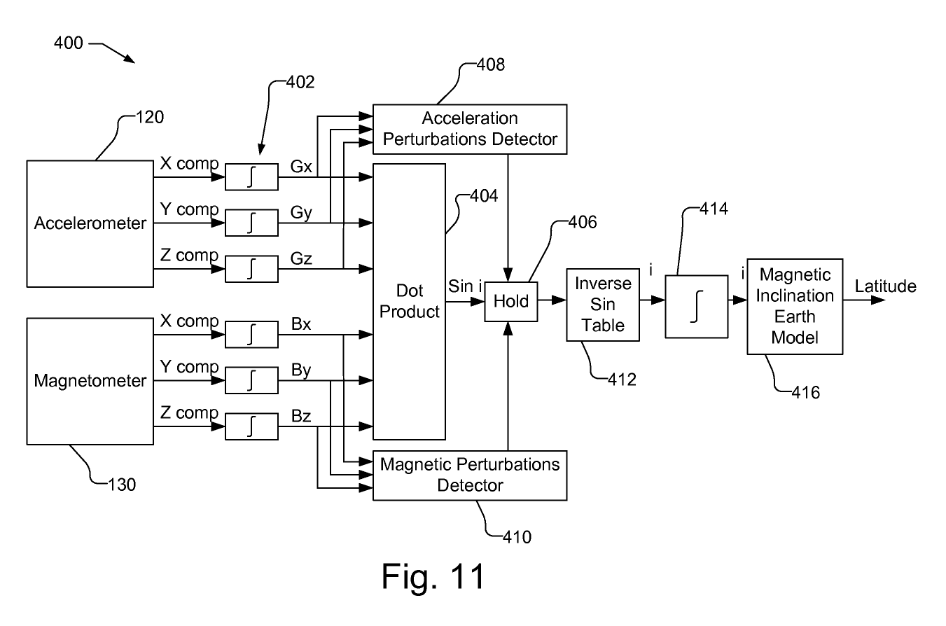

FIG. 11 is a block diagram 400 illustrating the determination of a value of at least one feature of the Earth's magnetic field using the magnetometer 120 and accelerometer 130 (block 202 of FIG. 9) and using the value of the feature to determine an approximate latitude of the mobile station (block 204 of FIG. 9). It should be understood, as discussed above, that the features described in block diagram 400 may be implemented in hardware, firmware, or software or some combination thereof. As shown in FIG. 11, the magnetometer 120 and accelerometer 130, each provide three component measurements, labeled X comp, Y comp, and Z comp. The measurements from the magnetometer 120 and accelerometer 130 can be made at a rate, e.g., between 10 and 20 Hz. If desired, a short integration in the order of 0.2 seconds can be applied on all measurements to filter out some measurement noise, as illustrated as integration elements 402. The integration elements 402 produce three magnetic field data values (Bx, By, and Bz) from the magnetometer 120 and three acceleration data values (Gx, Gy, and Gz) from the accelerometer 130. The instantaneous value of the inclination i can be extracted from the six measured data values using, e.g., the following dot-product formula:

$$\begin{matrix}sin i = cos ( \frac{π}{2} - i ) \\ = \frac{Gx \cdot Bx + Gy \cdot By + Gz \cdot Bz}{\sqrt{{Gx}^{2} + {Gy}^{2} + {Gz}^{2}} \cdot \sqrt{{Bx}^{2} + {By}^{2} + {Bz}^{2}}} .\end{matrix} \qquad eq . 1$$

Thus, as illustrated in FIG. 11, the six data values (Bx, By, Bz, Gx, Gy, and Gz) may be provided to dot product logic 404, which generates a signal Sin i.

As discussed above, if desired additional or different features of the magnetic field may be used. For example, the vertical intensity of the magnetic field may be used of or in addition to the inclination. The instantaneous value of the vertical intensity vi can be can be extracted from the six measured data values using the dot product logic 404 applying, e.g., the following dot-product formula:

$$vi = \frac{Gx \cdot Bx + Gy \cdot By + Gz \cdot Bz}{\sqrt{{Gx}^{2} + {Gy}^{2} + {Gz}^{2}}} . \qquad eq . 2$$

If the total intensity of the magnetic field is to be used, e.g., in place of or in addition to one or both of the inclination and the vertical intensity, the instantaneous value of the total intensity ti can be extracted from the three data values from the magnetometer by logic 404 using, e.g., the following formula:

ti=\sqrt{Bx²+By²+Bz²}. eq. 3

As illustrated in FIG. 11, a hold element 406 may be used to receive the instantaneous inclination Sin i value produced by the dot product logic 404. Hold element 406 also receives input signals from an acceleration perturbation detector 408 and a magnetic perturbation detector 410. The magnetic perturbation detector 410 receives the three data values (Bx, By, and Bz) from the magnetometer 120 and detects perturbations in the magnetic field. For example, the magnetic perturbation detector 410 may detect whether the total intensity value falls within the expected range of 30 to 60 microteslas. A measured value outside this range indicates the presence of an error source, such as a large metallic mass or non-terrestrial magnetic field, that will generate an inaccurate estimation of the inclination. The magnetic perturbation detector 410 provides a signal to the hold element 406 indicating the presence of a perturbation in the magnetic field and, in response, the hold element 406 prevents the corresponding and perturbed instantaneous inclination Sin i value from being integrated in the integration element 414.

Similarly, the acceleration perturbation detector 408 receives the three data values (Gx, Gy, and Gz) from the accelerometer 130 and analyzes the data to determine if a perturbation in the dynamics on the accelerometer 130 is present. For example, the acceleration perturbation detector 408 may detect whether the total acceleration is within an expected range around 1 G, e.g., 1.0 G±0.25 G. A different expected range may be used, but the range should be large enough to accommodate geographical variations in gravity acceleration, which may vary approximately 0.5% from pole to equator. A measured value outside the expected range indicates the presence of an error source, such as a large amount of user motion, which will generate an inaccurate estimate of inclination. Accordingly, the acceleration perturbation detector 408 provides a signal to the hold element 406 indicating the presence of a perturbation in the dynamics and, in response, the hold element 406 prevents the corresponding instantaneous inclination Sin i value from being integrated by the integration element 414.

If no perturbations are present, the hold element 406 provides the instantaneous inclination Sin i value to be compared to an inverse Sin table 412, thereby producing an instantaneous inclination i value. It should be understood that the hold element 406, if used, may be located after the inverse Sin table 412, if desired. The dot product logic 404, hold element 406, and inverse Sin table 412 may be updated at a rate of 1 sample every 0.2 s, as are the detections by the acceleration perturbation detector 408 and magnetic perturbation detector 410.

As illustrated in FIG. 11, the instantaneous inclination i value is provided to a integration element 414, which performs a long term integration, e.g., over a period of time 10 seconds to 2 minutes or more, to filter out the effects of metallic masses on the magnetometer 120 and dynamics, e.g., movement of the mobile station 100, on the accelerometer 130 thereby improving the accuracy of inclination estimate. As discussed above, the magnetometer 120 is sensitive to the local metallic masses and the accelerometer 130 is sensitive to user motion. Accordingly, the magnetometer 120 and accelerometer 130 may provide false instantaneous magnetic field and local vertical information when a local metallic mass is nearby or when the user is in motion, even if the measured values are within the acceptable ranges of the magnetic perturbation detector 410 and acceleration perturbation detector 408. Thus, for example, user motion may produce an instantaneous acceleration that will result in an instantaneous local vertical that is incorrect. Over time, however, the average acceleration is zero even when there is user motion. The individual measurements of gravity and magnetic field are high frequency, while the inclination value i is quasi constant. Consequently, the inclination value i can be filtered over a long period of time to reduce or eliminate the effects of the temporary presence of metallic masses or user motion. The filtering of the instantaneous inclination i value may be performed in the background at a low rate so that the solution is ready when needed. By way of example, integration element 414 may produce an instantaneous inclination i value every 10 seconds.

The integration element 414 produces an average inclination i value that is then compared to the magnetic inclination Earth model 416, which may be a table of inclination values with respect to latitude, to convert the inclination i value to an approximate latitude of the mobile station, which is stored in memory 154. The final measurement after model 416 may be produced once every 10 seconds. The approximate latitude can then be used to determine the satellite visibility list, and thus reduce the GPS or GNSS satellite search time and complexity in an autonomous mode. It can be also used for seeding the position computation algorithms to converge faster to the true position.

As discussed above, other features of the Earth's magnetic field may be additionally or alternatively used. For example, the vertical intensity or the total intensity may be used in the determination of the latitude in a manner similar to that described above and in FIG. 11, except that the inverse Sin table 412 would be unnecessary and the appropriate magnetic Earth model 416 would be used.

The position of the mobile station can be further narrowed by determining an approximate longitude. In general, no magnetic field features exist with iso lines neatly aligned roughly in a North-South fashion along the meridians. The declination shown in FIG. 5 has some vertical iso-lines, but declination requires a knowledge of true North, which neither the magnetometer 120 nor the accelerometer 130 can provide. The total intensity also has some vertical iso lines, however, the total intensity includes significant ambiguities and a large variability over time. Nevertheless, it may be possible to combine two or more magnetic field feature measurements, such as inclination and total intensity, to derive an approximate longitude. Thus, using the magnetometer 120 and accelerometer 130, an approximate latitude and longitude may be derived. The solution for longitude, however, may not be unique, i.e., more than one longitude will have the same combination of values for the measured magnetic field features. Additional geographic or environmental information may be received by the mobile station 100 and used in conjunction with the magnetic field feature measurements to further refine the approximate longitude. For example, geographic area designators, such as area code or country code, commonly used in telephone systems, may be received from a local cellular tower 104 by transceiver 143 and used with the magnetic field feature measurements to refine the approximate longitude. Other environmental information such as the altitude of the mobile station 100, as determined by altimeter 147, visible base stations, or visible radio signals as received by receiver 140 or transceiver 143 may be used to assist in determining longitude. An approximate longitude, even if non-unique, derived from magnetic field features with or without additional information such as area code, country code, or altitude, nevertheless, may be used to further narrow the satellite visibility list. Moreover, in some embodiments, the approximate longitude and approximate latitude may have sufficient resolution that it may be used in place of a satellite positioning system.

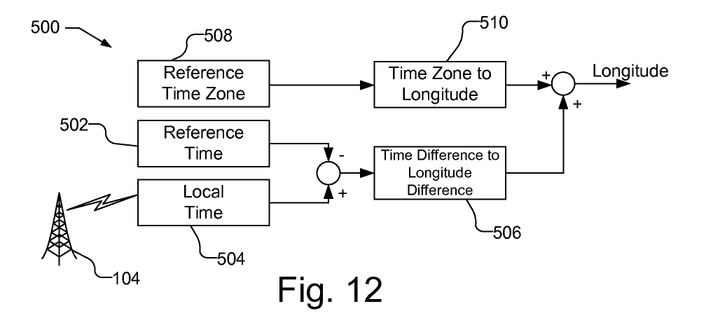

Referring to FIG. 9, an approximate longitude of the mobile station may be determined using the time difference between the local time zone and a reference time zone (206). FIG. 12 is a block diagram 500 illustrating the determination of longitude based on the time difference between the local time and a reference time. The reference time is the time at a location with a known position, e.g., the location of the last good fix, a permanent location such as a home location or other known location, e.g., Greenwich, and may include the time of a time zone where the position of the time zone is a range of longitudes. As illustrated, to produce a time difference, the reference time 502 is compared to a local time 504, which may be obtained from a time signal from a local cellular tower 104 or wireless communication access point 106 (shown in FIG. 1) that is received by mobile station 100, or by user input via the keypad 164. In one embodiment, the time difference is calculated as the difference in the time at the local time zone and the time at the reference time zone. The time at the reference time zone may be maintained, e.g., by a clock 153. In another embodiment, the time difference is determined by counting the number of time zones between the local time zone and the reference time zone. For example, the mobile station 100 may increment or decrement a count, depending on direction of travel, for every time zone between the local time zone and the reference time zone. The count may be stored, e.g., in memory 154, and may be updated as necessary whenever the mobile station 100 updates the local time.

The time difference between the reference time 502 and the local time 504 is converted to a longitude difference (506). Aside from some specific locations (e.g., where the time zones are incremented by half an hour), the time zones are in integer numbers of hours difference, where one hour is equivalent to 15° of longitude, and thus, the uncertainty is ±7.5° or ±8000 km at the equator.

Additionally, the reference time zone 508 is converted into a longitude 510, which may be stored, e.g., in memory 154. The longitude difference 506 is combined with the reference longitude 510 to determine the approximate longitude of the mobile station 100, which is stored in memory 154.

With an approximate latitude determined using a feature of the Earth's magnetic field, and an approximate longitude determined by comparing the local time and the time at a home location, the approximate position of the mobile station 100 is a roughly square cell, which at the equator has total dimensions of 1100 km in latitude by 1600 km in longitude.

Referring to FIG. 9, the approximate latitude and approximate longitude may then be used to assist in searching for satellites (208). The mobile station 100 may compare the approximate latitude and approximate longitude with the last position fix to determine if the last position fix may be used as a seed position. If the mobile station has not moved significantly, e.g., the last position fix is consistent with the approximate latitude and approximate longitude, the mobile station 100 may use the last position fix as the seed position for the search and use a moderately sized initial search window, e.g., on the order of miles or tens of miles, based on that seed position. If, however, the last position fix is not consistent with the approximate latitude and approximate longitude, the approximate latitude and approximate longitude may be used as the seed position and the search window is enlarged based on the uncertainty in the approximate latitude and approximate longitude. Thus, instead of performing a worldwide search, which is slow, the approximate latitude and approximate longitude may be used along with the almanac information to generate a reduced list of satellites are visible, and thus reduce the GPS or GNSS satellite search time and complexity in an autonomous mode. The visible satellite list may be stored, e.g., in memory 154, and a search conducted by the mobile station 100 in response to the list.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
determining an approximate latitude of a mobile station using a mobile station processor based on at least one feature of the Earth's magnetic field measured by the mobile station;
determining an approximate longitude of the mobile station using the mobile station processor; and
storing the approximate latitude and the approximate longitude and using the approximate latitude and the approximate longitude in the search for satellites in a satellite positioning system (SPS) that are visible to the mobile station during search and acquisition of satellite signals for a position fix.

2. The method of claim 1, wherein using the approximate latitude and the approximate longitude in the search for satellites in a satellite positioning system (SPS) that are visible to the mobile station during search and acquisition of satellite signals for a position fix comprises determining whether to use a last position fix for the mobile station as a seed position for the search for satellites by comparing the approximate latitude and the approximate longitude to a last position fix.

3. The method of claim 1, wherein using the approximate latitude and the approximate longitude in the search for satellites in a satellite positioning system (SPS) that are visible to the mobile station during search and acquisition of satellite signals for a position fix comprises using the approximate latitude and the approximate longitude as a seed position for the search for satellites.

4. The method of claim 1, wherein the at least one feature of the Earth's magnetic field is selected from inclination angle and vertical intensity.

5. The method of claim 1, wherein determining an approximate latitude of a mobile station using a mobile station processor based on at least one feature of the Earth's magnetic field measured by the mobile station comprises:
collecting data from a three-dimensional magnetometer inside the mobile station;
determining a value of the at least one feature of the Earth's magnetic field using the mobile station processor based on the collected data from the three-dimensional magnetometer; and
converting the value of the at least one feature into an approximate latitude.

6. The method of claim 5, wherein determining an approximate latitude of a mobile station using at least one feature of the Earth's magnetic field measured by the mobile station further comprises:
collecting local vertical data; and
using the local vertical data with the collected data from the three-dimensional magnetometer to determine the value of the at least one feature of the Earth's magnetic field.

7. The method of claim 5, wherein determining an approximate latitude of a mobile station using at least one feature of the Earth's magnetic field measured by the mobile station further comprises:
collecting data from a three-dimensional accelerometer inside the mobile station, the three-dimensional accelerometer having a known orientation with respect to the three-dimensional magnetometer; and
using the collected data from the three-dimensional accelerometer with the collected data from the three-dimensional magnetometer to determine the value of the at least one feature of the Earth's magnetic field.

8. The method of claim 7, further comprising filtering the data collected from the three-dimensional accelerometer and filtering the data collected from the three-dimensional magnetometer and using the filtered data collected from the three-dimensional accelerometer and the filtered data collected from the three-dimensional magnetometer to determine the value of the at least one feature of the Earth's magnetic field.

9. The method of claim 7, wherein using the collected data from the three-dimensional accelerometer with the collected data from the three-dimensional magnetometer to determine the value of the at least one feature of the Earth's magnetic field comprises:
generating an instantaneous value of the at least one feature of the Earth's magnetic field using the mobile station processor based on the collected data from the three-dimensional magnetometer with the collected data from the three-dimensional accelerometer; and
averaging the instantaneous value to produce the value of the at least one feature of the Earth's magnetic field.

10. The method of claim 7, further comprising:
detecting acceleration perturbations in the data collected from the three-dimensional accelerometer;
detecting magnetic perturbations in the data collected from the three-dimensional magnetometer; and
preventing the collected data from the three-dimensional accelerometer and the collected data from the three-dimensional magnetometer from being used to determine the value of the at least one feature of the Earth's magnetic field when at least one of detected acceleration perturbations and detected magnetic perturbations are outside a range.

11. The method of claim 1, wherein determining an approximate longitude of the mobile station using the mobile station processor is based on a time difference between a local time zone and a reference time zone and comprises:
storing a longitude from the reference time zone;
determining the time difference between the local time zone and the reference time zone;
converting the time difference to a longitude difference; and
using the longitude difference and the longitude from the reference time zone to determine the approximate longitude of the mobile station.

12. The method of claim 11, wherein determining the time difference between the local time zone and the reference time zone comprises determining the number of times zones between the local time zone and the reference time zone.

13. The method of claim 11, wherein determining the time difference between the local time zone and the reference time zone comprises calculating the difference in time at the local time zone and time at the reference time zone.

14. The method of claim 1, wherein determining an approximate longitude of the mobile station using the mobile station processor is based on a received area code or country code signal.

15. A mobile station comprising:
a three-dimensional magnetometer;
a three-dimensional accelerometer;
a satellite positioning system receiver;
a processor connected to receive data from the satellite positioning system receiver, data from the three-dimensional magnetometer and data from the three-dimensional accelerometer;
memory connected to the processor; and
software held in the memory and run in the processor to determine a value of the at least one feature of the Earth's magnetic field using the data from the three-dimensional magnetometer and the data from the three-dimensional accelerometer and to determine an approximate latitude using the value of the at least one feature of the Earth's magnetic field, and to use the approximate latitude in the search for satellites in a satellite positioning system (SPS) that are visible to the satellite positioning system receiver during search and acquisition of satellite signals for a position fix.

16. The mobile station of claim 15, further comprising a receiver that receives an external local time signal, wherein software held in the memory and run in the processor causes the processor to determine a time difference between the local time zone obtained from the external local time signal and a reference time zone, to determine an approximate longitude using the time difference, and to use the approximate longitude to determine a position fix for the mobile station.

17. The mobile station of claim 16, wherein a longitude from the reference time zone is stored in the memory, the software held in the memory and run in the processor causes the processor to convert the time difference to a longitude difference and combines the longitude difference and the stored longitude to determine the approximate longitude.

18. The mobile station of claim 16, wherein the software held in the memory and run in the processor causes the processor to determine the time difference between the local time zone obtained from the external local time signal and the reference time zone by at least one of determining the number of times zones between the local time zone and the reference time zone and calculating the difference in time at the local time zone and time at the reference time zone.

19. The mobile station of claim 15, further comprising a receiver that receives an external area code or country code signal, wherein the software held in the memory and run in the processor causes the processor to determine an approximate longitude based on the area code or country code signal.

20. The mobile station of claim 15, wherein the at least one feature of the Earth's magnetic field is selected from inclination angle and vertical intensity.

21. The mobile station of claim 15, further comprising a first filter that filters the data from the three-dimensional accelerometer and a second filter that filters the data from the three-dimensional magnetometer before the processor determines a value of the at least one feature of the Earth's magnetic field.

22. The mobile station of claim 21, wherein software held in the memory and run in the processor causes the processor to be the first filter and the second filter.

23. The mobile station of claim 15, wherein the processor determines the value of the at least one feature of the Earth's magnetic field by generating an instantaneous value of the at least one feature of the Earth's magnetic field and filters the instantaneous value to produce the value of the at least one feature of the Earth's magnetic field.

24. The mobile station of claim 15, wherein software held in the memory and run in the processor causes the processor to detect acceleration perturbations in the data from the three-dimensional accelerometer and detect magnetic perturbations in the data from the three-dimensional magnetometer and prevent the data from the three-dimensional accelerometer and the data from the three-dimensional magnetometer from being used to determine a value of the at least one feature of the Earth's magnetic field when at least one of detected acceleration perturbations and detected magnetic perturbations are outside a range.

25. The mobile station of claim 15, wherein software held in the memory and run in the processor causes the processor to use the approximate latitude in the search for satellites in a satellite positioning system (SPS) that are visible to the satellite positioning system receiver during search and acquisition of satellite signals for a position fix comprises software run in the processor causing the processor to determine whether to use a last position fix for the mobile station as a seed position for the search for satellites by comparing the approximate latitude to a last position fix.

26. The mobile station of claim 15, wherein software held in the memory and run in the processor causes the processor to use the approximate latitude in the search for satellites in a satellite positioning system (SPS) that are visible to the satellite positioning system receiver during search and acquisition of satellite signals for a position fix comprises software run in the processor causing the processor to use the approximate latitude as a seed position for the search for satellites.

27. A mobile station comprising:
means for measuring at least one feature of the Earth's magnetic field;
means for determining an approximate latitude of the mobile station using the measured at least one feature of the Earth's magnetic field;
means for determining an approximate longitude of the mobile station; and
means for using the approximate latitude and the approximate longitude in the search for satellites in a satellite positioning system (SPS) that are visible to the mobile station during search and acquisition of satellite signals for a position fix.

28. The mobile station of claim 27, wherein the means for measuring at least one feature of the Earth's magnetic field comprises a three-dimensional magnetometer and a three-dimensional accelerometer that has a known orientation with respect to the three-dimensional magnetometer, and a processor that receives data from the three-dimensional magnetometer and the three-dimensional accelerometer and calculates a value for the at least one feature of the Earth's magnetic field.

29. The mobile station of claim 28, further comprising a means for filtering out perturbation effects of metallic masses on the three-dimensional magnetometer and motion of the three-dimensional accelerometer.

30. The mobile station of claim 28, further comprising a means for detecting acceleration perturbations; a means for detecting magnetic perturbations; and a means to prevent the data from the three-dimensional accelerometer and the data from the three-dimensional magnetometer from being used to calculate a value for the at least one feature of the Earth's magnetic field when at least one of detected acceleration perturbations and detected magnetic perturbations are outside a range.

31. The mobile station of claim 27, wherein the means for determining an approximate latitude of the mobile station using the measured at least one feature of the Earth's magnetic field comprises a processor that converts the measured at least one feature of the Earth's magnetic field into an approximate latitude.

32. The mobile station of claim 27, wherein the means for determining an approximate longitude of the mobile station comprises a clock receiver that receives a local time signal; memory storing the longitude from the reference time zone and a processor coupled to the memory and the clock receiver, the processor determines the time difference between the local time zone determined from the local time signal received by the clock receiver and the reference time zone; the processor converts the time difference into a longitude difference; and combines the longitude difference and the longitude from the reference time zone to determine the approximate longitude.

33. The mobile station of claim 27, wherein the means for determining an approximate longitude of the mobile station comprises a receiver for receiving an area code or country code signal and a processor coupled to the receiver, the processor determines the approximate longitude based on the area code or country code signal received by the receiver.

34. The mobile station of claim 27, wherein the at least one feature of the Earth's magnetic field is selected from inclination angle and vertical intensity.

35. The mobile station of claim 27, wherein the means for using the approximate latitude and the approximate longitude in the search for satellites in a satellite positioning system (SPS) that are visible to the mobile station during search and acquisition of satellite signals for a position fix determines whether to use a last position fix for the mobile station as a seed position for the search for satellites by comparing the approximate latitude and the approximate longitude to a last position fix.

36. The mobile station of claim 27, the means for using the approximate latitude and the approximate longitude in the search for satellites in a satellite positioning system (SPS) that are visible to the mobile station during search and acquisition of satellite signals for a position fix uses the approximate latitude and the approximate longitude as a seed position for the search for satellites.

37. A computer-readable medium including program code stored thereon, comprising:
program code to determine the value of at least one feature of the Earth's magnetic field using magnetometer data referenced to a local vertical direction;
program code to determine an approximate latitude mobile station using the value of the at least one feature of the Earth's magnetic field; and
program code to use the approximate latitude in the search for satellites in a satellite positioning system (SPS) that are visible to the mobile station during search and acquisition of satellite signals for a position fix.

38. The computer-readable medium of claim 37, further comprising program code to determine an approximate longitude using the time difference between a local time zone and a reference time zone.

39. The computer-readable medium of claim 37, further comprising program code to determine an approximate longitude using a local area code or country code.

40. The computer-readable medium of claim 37, wherein the program code to determine the value of at least one feature of the Earth's magnetic field using magnetometer data referenced to a local vertical direction comprises program code to calculate at least one of inclination angle and vertical intensity using magnetometer data and accelerometer data.
